(19) United States
(12) Patent Application Publication
(10) Pub. No.: US 2004/0220995 A1
(43) Pub. Date: Nov. 4, 2004

(54) Method, program, and apparatus for delegating information processing

(76) Inventor: Takehiko Tsutsumi, Kamakura-shi (JP)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/475,686

(22) PCT Filed: Apr. 19, 2002
(86) PCT No.: PCT/US02/12276

(30) Foreign Application Priority Data
Apr. 23, 2001 (JP) 2002-124060

(51) Int. Cl. G06F 15/16

(52) U.S. Cl. 709/200

(57) ABSTRACT

An inexpensive network service without time constraints is provided to an information terminal through delegation thereof. A method for delegating information processing includes the steps of: establishing a wireless link between a first information terminal (10) and a second information terminal (20) located nearby; providing, from the second information terminal, an information processing delegation certificate to the first information terminal via the wireless link, and requesting the first information terminal for the delegation of desired information processing, such as information transmission processing or information reception processing; the first information terminal moving to the neighborhood of access service equipment for a wide-area network (40); establishing a wireless link between the first information terminal and access service equipment; performing, at the first information terminal, information processing with the wide-area network via the access service equipment, based on the request; the first information terminal moving back to the neighborhood of the second information terminal, where the wireless link is re-established between the two terminals; and the first information terminal reporting to the second information terminal the results of the requested information processing.

### FIELD OF THE INVENTION

The present invention relates to methods, apparatuses, and programs for delegating information processing, and, more specifically, to a method and for requesting via a wireless link, delegation of information processing between two information terminals

### BACKGROUND OF THE INVENTION

The mode of wireless information transmission and reception that is conventionally performed by portable information terminals is show in FIG. 1. As portable information terminals, such as handheld game machines and personal digital assistants (PDAs), are equipped with a wireless module, such as a radio module or infrared module, head-to-head-competition game playing or data exchanges can be achieved between two portable information terminals. Additionally, the portable information terminal can access the Internet via a cellular phone or handset and a cellular telephone network, so that (a) content may be downloaded from a desired server to upgrade its software, or (b) news reception, e-mail transmission and reception, and e-commerce transactions may be performed.

However, a cellular telephone system suffers high usage fees due to coverage of its base stations and limited radio resources. Thus, usage fees especially become prohibitive and thus unrealistic, when large amounts of content are downloaded or Internet access is conducted for a relatively long period of time, such as e-mail transmission and reception or e-commerce transactions.

In another prior art method, a hot-spot access service is also available, as shown in FIG. 2. This is a radio access service at public spots, such as airports and stations, where hot-spot access service equipment provides a connection to the Internet via inexpensive means, such as cable communication, so that Internet access services are provided to portable information terminals located in the hot-spot service area via a radio link. When located in the hot-spot service area, the portable information terminal establishes a short-range radio communication link with the access service equipment to allow access to the Internet, so that (a) content may be downloaded from a desired server to upgrade its software, or (b) news reception, e-mail transmission and reception, and e-commerce transactions may be performed. Although this service system eliminates the need for expensive telephone charges and thus involves low cost, there is a disadvantage that service cannot be enjoyed unless one takes the trouble to go to the hot spot.

Accordingly, the present invention provides a network service to information terminals that is inexpensive and involves no time constraints.

### BRIEF DESCRIPTION OF THE DRAWINGS

FIG. 1 is a schematic diagram illustrating the mode where a prior art portable information terminal accesses the Internet via a handset or cellular phone.

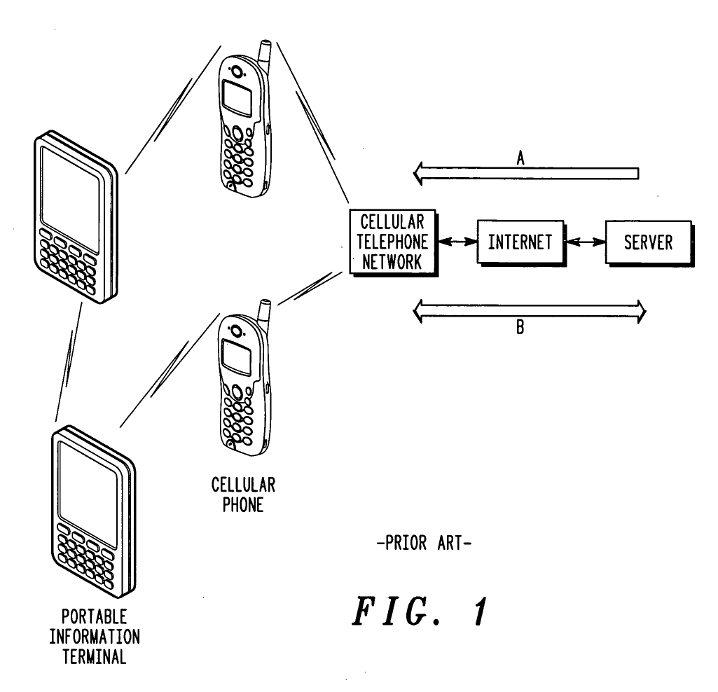

FIG. 2 is a schematic diagram illustrating the mode where a prior art portable information terminal accesses the Internet via hot-spot access service equipment.

FIG. 3 is a schematic diagram illustrating delegation of information processing according to one embodiment of the present invention.

FIG. 4 is a block diagram of a wireless module according to one embodiment of the present invention.

### DETAILED DESCRIPTION OF THE INVENTION

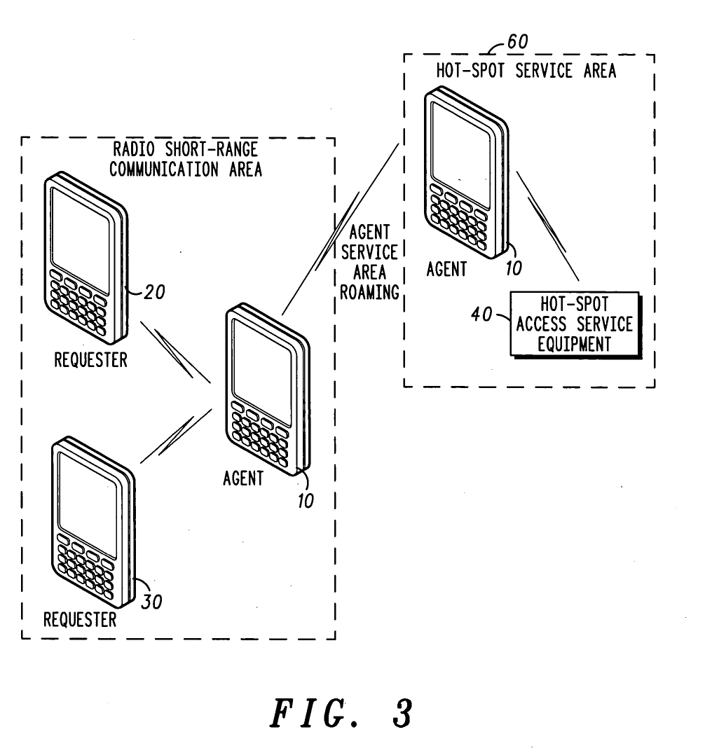

An embodiment of the present invention is described below with reference to the drawings. FIG. 3 shows portable information terminals 10, 20 and 30. The portable information terminals 10, 20, 30 include, among others, handheld game machines, such as Nintendo Gameboy, and electronic organizers or digital personal assistants (PDAs), such as Palm. The portable information terminals 10, 20, 30 are equipped with a short-range wireless communication capability over a short distance of several meters at most, by incorporating wireless communication modules 11, 21, and 31, such as radio or infrared modules, or adding them as external functionality. This wireless communication capability allows the portable information terminals 10, 20, 30 to communicate with one another and exchange various types of data.

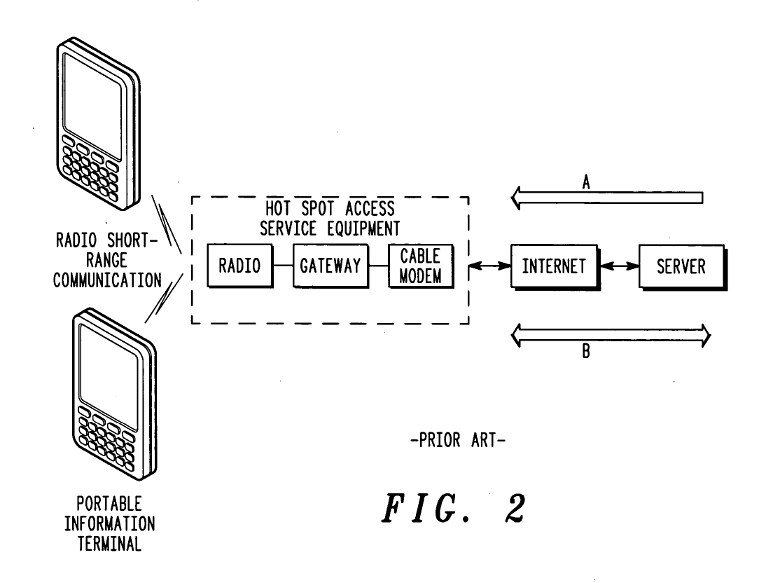

Hot-spot access service equipment 40 shown in FIG. 3, which is similar to that shown in FIG. 2, provides a connection to the Internet via inexpensive communication means, such as cable and xDSL communication, so that an access service for a wide-area network, such as the Internet, for example, is provided, via a wireless link, to portable information terminals located in the hot-spot service area. With recent advances in wireline communication technology, the usage fees for the wireline-based Internet are lowered drastically, with always-on connection service based on a cable modem or xDSL is offered at several thousands yen or lower. Using such an inexpensive wireline Internet infrastructure, access service equipment combining a controller (see FIG. 2) having a so-called gateway function and a wireless unit, such as a radio unit, having a capability of short-range communication with portable information terminals is installed in a place (hot spot) that attracts owners of portable information terminals. Hot spots include, for example, school campuses, convenience stores, stations, parks, shopping areas, and game centers.

The access service equipment 40 can concurrently provide Internet access services to a plurality of portable information terminals located in a service area 60. When data of commercial value is to be sent and received between a provider who offers information service or e-commerce service and a portable information terminal via the wireless link, preferably known security measures are used. Thus, it is desirable that the gateway implement communication software that locks security, such as virtual private network (VPN), for example. By installing such access service equipment 40 at each of a plurality of hot spots 60, typical Internet functions, such as general news delivery, advertisement transmission, reception of bulletin board information, transmission and reception of e-mail, chats, access to home pages, and e-commerce transactions, can be offered to portable information terminals located within the area 60. Additionally, specific services customized to specific portable information terminals may also be offered. Because such hot spots may be readily optimized by preferentially selecting places that most likely attract people, initial investment costs can be reduced.

When the portable information terminal 20 wishes to receive a certain Internet access service, it must move into some hot-spot service area. However, if it cannot move for some reason, or will be able to move in the future but wants to receive the service as immediately as possible at this moment, it can cause another portable information terminal 10 to perform information processing, such as information transmission and/or reception processing. For such delegation of information processing, the portable information terminal 10 (Slave) includes software for executing an agent or delegation function. An appropriate agent or delegation certificate is granted from the requesting portable information terminal 20 (Master) to the portable information terminal 10 (Slave). The portable information terminal 10 to which the delegation certificate is granted moves into the hot-spot service area 60 and receives a necessary service via the access service equipment 40; the terminal 10 then moves back to its previous location and passes the requested service to the requesting portable information terminal 20 and deletes the agent certificate. In this way, the portable information terminal 20 (Master) that grants the agent certificate can receive the desired service without having to move to the hot-spot service area 60.

Because Internet access services for the portable information terminal do not necessarily demand real time, except in cases of chats and viewing of home pages, service offering by use of delegation will not pose any problem. However, since the agent certificate requires sufficient caution in terms of security, it is desirable that authentication IDs that are granted according to the degree of service requested are distinguished, as appropriate. For example, a group ID may be set for transmission and reception of bulletin-board content; a user ID may be set for transmission and reception of e-mail; mail; a password and an upper ceiling for transaction money may additionally be set for e-commerce transactions. Furthermore, the capability of deleting the agent certificate is also important; the function should desirably be installed to prevent a portable information terminal to which the agent certificate is granted from misusing its authentication ID. On the other hand, for public or otherwise disclosed information that are required to be delivered actively, such information may be conveyed to an unspecified number of portable information terminals that are accidentally encountered during roaming, even without authentication IDs.

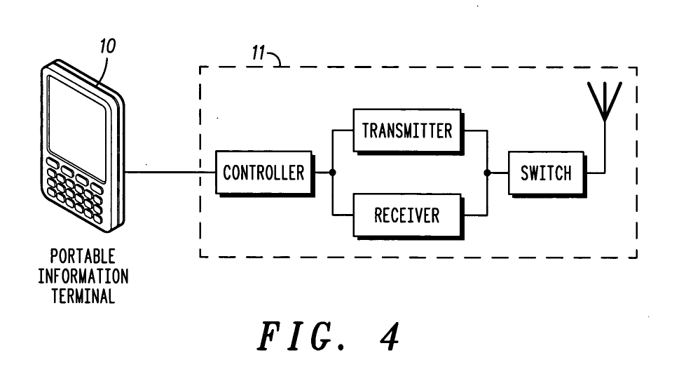

A wireless module that is incorporated into or added externally to the portable information terminal may be of general configuration as shown in FIG. 4. The communication scheme of the wireless module may be infrared, radio, or other wireless communication, and various protocols may be used.

An embodiment of the operation where delegation of information processing is requested and a report of the processing requested is received is described. First, the portable information terminal 20 that serves as a requester wishes Internet access (such as, for example, transmission and reception of e-mail). However, the portable information terminal 20 has no plan to immediately go to a hot-spot service area. Thus, it requests to the nearby portable information terminal 10 the delegation of Internet access processing. This request for delegation is performed via a link established between the wireless modules 21 and 11. The request for delegation includes granting a delegation certificate or agent certificate from the portable information terminal 20 to the portable information terminal 10, conveyance of delegated processing content, and transfer of ID and/or password. Upon accepting the request, the portable information terminal 10 moves into the hot-spot service area 60. Then, a wireless link is established between the hot-spot access service equipment 40 and the portable information terminal 10. The portable information terminal 10 accesses the Internet via the established wireless link, and executes the requested information processing content. For e-mail transmission alone, the delegation of information processing may be terminated at that moment. If the delegation of information processing is not yet terminated, the portable information terminal 10 subsequently returns to the neighborhood (over a distance where a wireless link may be established) of the portable information terminal 20. A wireless link is re-established between the portable information terminals 10 and 20, and the portable information terminal 10 reports, via that link, to the portable information terminal 20 the content of the information processing executed (for example, delivery of e-mail received). The terminal 10 also deletes the delegation certificate.

If information processing from the Internet (for example, news delivery or advertising transmission) is desired, the access service equipment 40 transmits to the nearby portable information terminal 10 a request for delegation of information processing for other portable information terminals. This request for delegation is made via a wireless link established between the access service equipment 40 and wireless module 11. The request for delegation includes granting a delegation certificate or agent certificate from the access service equipment 40 to the portable information terminal 10, conveyance of delegated processing content, and transfer of ID and/or password. For requests for general delegated processing that does not require privacy, transfer of ID and/or password may be omitted. Upon acceptance of the request for delegated processing, the portable information terminal 10 moves to the neighborhood of another portable information terminal (for example, portable information terminal 30). A wireless link is established between the portable information terminal 30 and the portable information terminal 10 that has moved thereto. The portable information terminal 10 conveys, via the wireless link established, the information requested from the Internet, to the portable information terminal 30.

The embodiment of the present invention offers the following benefits by combining the prior art hot-spot service and the portable information terminal equipped with the agent capability. In consideration of the installation cost for access service equipment and delegation service time for the portable information terminal to which a request for delegation is made, a far more inexpensive and optimized service can be offered, as compared to the cellular telephone service. A requesting portable information terminal may enjoy a wide-area network service without paying any telephone charge.

1. A method for delegating information processing, comprising the steps of:
establishing a wireless link between a first information terminal and a second information terminal located nearby;
providing from the second information terminal, an information processing delegation certificate to the first information terminal via said wireless link, and the second information terminal requesting the first information terminal to perform desired information processing, such as information transmission processing or information reception processing;
the first information terminal moving to a neighborhood of access service equipment for a wide-area network;
establishing a wireless link between the first information terminal and said access service equipment; and
performing, at the first information terminal, said desired information processing with the wide-area network via said access service equipment, based on said request.

2. The method for delegating information processing according to claim 1, further comprising:
the first information terminal moving to the neighborhood of the second information terminal, and re-establishing the wireless link between the two terminals; and
the first information terminal reporting to the second information terminal the results of said requested information processing.

3. A method for delegating information processing, comprising the steps of:
establishing a wireless link between access service equipment for a wide-area network and a first information terminal;
requesting, at said access service equipment, the first information terminal for delegation of desired information transmission processing, via said wireless link;
the first information terminal moving to the neighborhood of a second information terminal;
establishing a wireless link between the first information terminal and second information terminal; and
processing, at the first information terminal, said information transmission processing for the second information terminal, based on said request.

4. The method for delegating information processing according to claim 3, wherein said wide-area network is the Internet.

5. The method for delegating information processing according to claim 3, wherein said first information terminal is a portable information terminal.

6. The method for delegating information processing according to claim 3, wherein said second information terminal is a portable information terminal.

7. A program for causing a processor that controls operation of a first information terminal to execute steps to delegate information processing to the first information terminal, the steps comprising:
establishing a wireless link between the first information terminal and a second information terminal located nearby;
receiving an information processing delegation certificate from the second information terminal via said wireless link, and causing the first information terminal to accept the delegation of information processing desired by the second information terminal, such as information transmission processing or information reception processing;
detecting that the first information terminal has moved to the neighborhood of access service equipment for a wide-area network;
establishing a wireless link between the first information terminal and said access service equipment; and
causing the first information terminal to perform said information processing with the wide-area network via said access service equipment, based on said acceptance of the delegation.

8. The program according to claim 7, further causing the processor to execute the steps of:
detecting that the first information terminal has moved to the neighborhood of the second information terminal, and re-establishing a wireless link between the two terminals; and
causing the first information terminal to report to the second information terminal results of said requested information processing.

9. A program for causing a processor that controls operation of a first information terminal to execute steps to delegate information processing to the first information terminal, the steps comprising:
establishing a wireless link between access service equipment for a wide-area network and the first information terminal;
causing the first information terminal to accept, via said wireless link, the delegation of information transmission processing desired by said access service equipment;
detecting that the first information terminal has moved to the neighborhood of a second information terminal;
establishing a wireless link between the first information terminal and second information terminal; and
causing the first information terminal to perform said information transmission processing for the second information terminal, based on said request.

10. The program according to claim 9, wherein said wide-area network is the Internet.

11. The program according to claim 9, wherein said first information terminal is a portable information terminal.

12. The program according to claim 9, wherein said second information terminal is a portable information terminal.

13. A wireless module for delegating information processing to a first information terminal, comprising: a controller, a transmitter, a receiver, and an antenna, said controller having the functions of:
establishing a wireless link between the first information terminal and a second information terminal located nearby;
receiving an information processing delegation certificate from the second information terminal via said wireless link and causing the first information terminal to accept the delegation of information processing desired by the second information terminal, such as information transmission processing or information reception processing;
detecting that the first information terminal has moved to the neighborhood of access service equipment for a wide-area network;
establishing a wireless link between the first information terminal and said access service equipment; and
causing, via said access service equipment, the first information terminal to perform said information processing with the wide-area network, based on said acceptance.

14. The wireless module according to claim 13, where in said controller further having the functions of:
detecting that the first information terminal has moved to the neighborhood of the second information terminal and re-establishing a wireless link between the two terminals; and
causing the first information terminal to report to the second information terminal said requested information processing.

15. A wireless module for delegating information processing to a first information terminal, comprising: a controller, a transmitter, a receiver, and an antenna, said controller having the functions of:
establishing a wireless link between access service equipment for a wide-area network and the first information terminal;
causing the first information terminal to accept, via said wireless link, the delegation of information transmission processing desired by said access service equipment;
detecting that the first information terminal has moved to the neighborhood of a second information terminal;
establishing a wireless link between the first information terminal and second information terminal; and
causing the first information terminal to perform said information transmission processing for the second information terminal, based on said request.

16. The wireless module according to claim 15, wherein said wide-area network is the Internet.

17. The wireless module according to claim 15, wherein said first information terminal is a portable information terminal.

18. The wireless module according to claim 15, wherein said second information terminal is a portable information terminal.
